(19) United States
(12) Patent Application Publication
(10) Pub. No.: US 2006/0098120 A1
(43) Pub. Date: May 11, 2006

(54) Method for acquiring data describing audio-visual contents, system, broadcast server, description server, and reception terminal therefor

(75) Inventor: Christian Bertin, Rennes (FR)

Correspondence Address: JAMES R. WILLIAMS;JAMISON, SELTZER, HARPER & WILLIAMS, 2625 WILMINGTON ROAD, NEW CASTLE, PA, 16105, US

(73) Assignee: France Telecom, Paris (FR)

(21) Appl. No.: 10/528,198

(22) PCT Filed: Sep. 5, 2003
(86) PCT No.: PCT/FR03/02659

§ 371 Date: Sep. 19, 2005

(30) Foreign Application Priority Data
Sep. 16, 2002 (FR) 02/11445

(51) Int. Cl. H04N 5/445; H04N 7/08; G06F 3/00; H04N 7/084; H04N 7/087; G06F 13/00

(52) U.S. Cl. 348/473; 348/563; 725/40

(57) ABSTRACT

The invention relates in particular to a method of acquiring description data for broadcast audiovisual content, the method comprising:

a step (28) in which a receiver terminal (12) transmits at least one information request to at least one server (16) of audiovisual content descriptions; and

a step (30) of the receiver terminal (12) receiving description data supplied as a function of elements of the request.

It further comprises a prior step (20, 22, 24) of acquiring and storing in the receiver terminal (12) at least one initial information request comprising the address of at least one audiovisual content description server (16) and a step (26) of generating the request on the basis of the previously-acquired initial request. The invention also provides a system, a broadcast server, a receiver terminal, and a description server for implementing the method.

The present invention relates to a method of acquiring description data about broadcast audiovisual content. The invention also relates to a system, a broadcast server, a description server, and a receiver terminal for implementing the method.

More precisely, the present invention relates to a method of the type comprising:

a step in which a receiver terminal transmits at least one request for information to at least one server of audiovisual content descriptions; and

a step of the receiver terminal receiving description data supplied in response to elements of the request.

Such description data acquisition methods are generally implementing in description servers that are accessible via the Internet. The Internet site of an audiovisual content broadcast channel thus proposes searching for audiovisual content that might be of interest to a user with the help of a search engine included in a home page.

Nevertheless, if a user desires to receive description data relating to audiovisual content as broadcast by a plurality of channels, the user must navigate to a plurality of Internet sites in order to make a plurality of requests.

An object of the invention is to remedy that drawback by providing a method of acquiring description data while facilitating the step of transmitting information requests in order to obtain the desired description data.

To this end, the invention provides a description data acquisition method of the above-specified type, characterized in that it includes a prior step of acquiring and storing in the receiver terminal at least one initial information request comprising the address of at least one audiovisual content description server and a step of generating the request on the basis of the previously-acquired initial request.

Thus, since the receiver terminal is capable of storing some number of initial requests, the step of request generation makes it possible to use a common interface for transmitting one or more requests.

Optionally, a description data acquisition method of the invention includes the characteristic whereby during the reception step, audiovisual content description data is supplied as a function of a relationship between at least one date and time associated with the request and the broadcast date and time of the audiovisual content.

An advantage of this acquisition method is that it enables description data to be received relating to audiovisual content broadcast at a particular time, or within a particular time period, without it being necessary to identify or reference any particular audiovisual content.

In addition, a description data acquisition method of the invention may comprise one or more of the following characteristics:

the date and time associated with the request corresponds to the date and time at which the request is transmitted;

the request as transmitted is identical to the initial request;

during the request generation step, the initial request is extended by specifying at least one date and time;

during the step of receiving description data the data supplied is that corresponding to audiovisual content broadcast at the date and time specified in the request;

during the request generation step, the initial request is extended by specifying a number of content items, and during the reception step, the data supplied corresponds to the requested number of audiovisual content items broadcast starting from the date and time specified in the request;

during the request generation step, the initial request is extended by specifying a time interval, and during the reception step, the data supplied relates to audiovisual content broadcast in the time interval specified in the request;

the time interval is defined by a start date and time and by an end date and time;

the time interval is defined by a start date and time and by a duration;

during the request generation step, the initial request is extended by specifying keywords corresponding to the names of description elements for broadcast audiovisual content;

following the step of receiving description data, the method returns to the request generation step in order to generate at least one new request associated with a new date and a new time corresponding to the end-of-broadcast date and time for the audiovisual content for which description data has just been received;

the step of acquiring and storing an initial request comprises downloading said request from a description server;

the step of acquiring and storing an initial step comprises the receiver terminal receiving said initial request via a signaling channel associated with an audiovisual content broadcast channel;

the step of acquiring and storing an initial request comprises a broadcast server supplying an SDP type file corresponding to an address field of a description server;

the description data is supplied in the form of an XML file;

the request is associated with a single audiovisual content broadcast channel;

while generating the request for transmission, a set of broadcast channels is defined, and during transmission step, as many requests are transmitted as there are broadcast channels specified in the request; and

the request generation step comprises adding at least one selection criterion to the initial request.

The invention also provides a system for acquiring description data for broadcast audiovisual channels, the system comprising at least one receiver terminal for receiving audiovisual content and at least one audiovisual content description server, the system being characterized in that the receiver terminal includes means for acquiring and storing at least one initial information request comprising the address of at least one description server, means for generating a request on the basis of the initial request, and means for transmitting said request to the description server, and in that the description server includes means for transmitting to the receiver terminal description data supplied as a function of the request.

The system of the invention may further include or more of the following characteristics:

the description server includes means for making an initial request available; and

the system includes at least one audiovisual content broadcast server, said server including means for transmitting initial requests together with the broadcast content.

The invention also provides an audiovisual content broadcast server for implementing a description acquisition method as described above, characterized in that it includes transmission means for transmitting initial requests together with the broadcast content.

A broadcast server of the invention may further comprise the characteristic whereby the transmission means are regular transmission means.

The invention also provides a receiver terminal for receiving audiovisual content to implement a description data acquisition method as described above, characterized in that it includes means for storing an initial request and means for generating a request to be transmitted on the basis of the initial request.

Finally, the invention also provides an audiovisual content description server for implementing a description data acquisition method as described above, the server being characterized in that it includes means for making an initial request available.

The invention will be better understood on reading the following description given purely by way of example and made with reference to the accompanying drawing, in which:

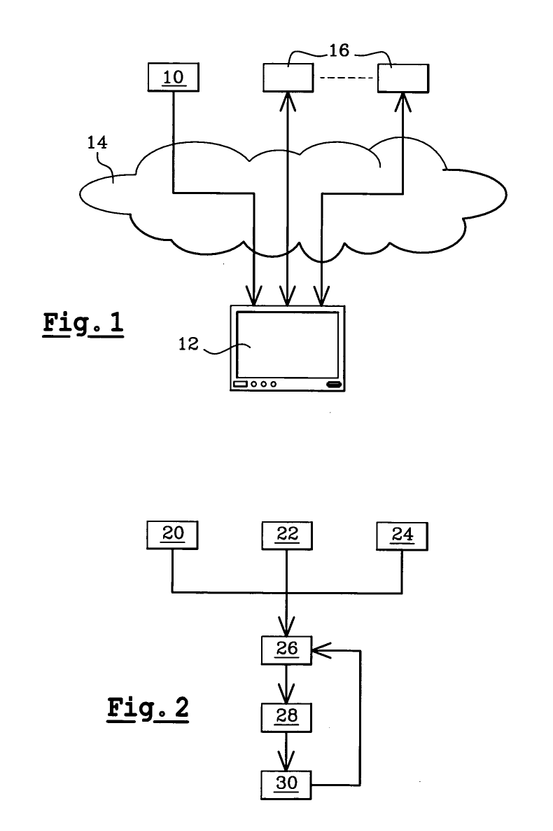

FIG. 1 is a diagram of a description data acquisition system of the invention; and

FIG. 2 shows the steps in a method of acquiring description data implemented by the system of FIG. 1.

The system shown in FIG. 1 comprises at least one broadcast server 10 suitable for programmed broadcasting of audiovisual content to a receiver terminal 12. A plurality of broadcast servers 10 may transmit programmed audiovisual content to the receiver terminal 12, said terminal having a plurality of reception channels.

In this example, broadcasting takes place over a conventional data transmission network such as the Internet. It could also take place over a radio broadcast network, by cable, or by satellite. The transmission network is represented by reference 14.

Audiovisual content description servers 16 are also connected to the Internet 14 in order to exchange data with the receiver terminal 12.

Each of these servers may be associated with a particular broadcast server or else with a set of broadcast servers. They are adapted to provide data describing audiovisual content in response to requests that are transmitted to them by the receiver terminal 12.

The system described above serves to implement the method shown in FIG. 2.

The method comprises a first step of the receiver terminal receiving and storing initial requests. This first step is represented by references 20, 22, and 24. It is subdivided into three different acquisition steps that can be executed independently of one another, simultaneously or at different times.

A first step 20 of acquiring an initial request comprises downloading such a request from one of the description servers 16. The downloaded request comprises at least an identifier of the broadcast source of audiovisual content corresponding to the description server.

A second step 22 of acquiring an initial request comprises the terminal 12 receiving said request in a signaling channel associated with the audiovisual content broadcast channel used by the broadcast server 10. Under such circumstances, the initial request is transmitted to the receiver terminal 12 in repeated manner, preferably regularly, so that the user of the receiver terminal 12 can store it in the terminal when so desired.

Finally, a third step 24 of acquiring an initial request comprises the broadcast server 10 supplying the receiver terminal 12 with a file of the session description protocol (SDP) type and corresponding to the source of audiovisual content. To do this, it suffices to add a field to the file of SDP type in order to supply the address of the description server 16 to be contacted in order to obtain the description data relating to the broadcast content. This is possible when the broadcast server 10 broadcasts audiovisual content via a network such as the Internet 14.

An initial request stored by the receiver terminal 12 comprises at least an identifier for a broadcast source and may take one of the following forms, for example:

http://kaas.example.com/scripts/metadata.xml? ServiceId=“tv1000201”&UTC=

http://kass.example.com/channel_one/metadata.xml? date_time=

http://kaas.example.com/scripts/channel_two.xml? time=

In the first example, the identifier of the broadcast source is recorded as a parameter of the request (parameter ServiceId=“tv1000201”). In the second example, the identifier of the broadcast source is a specific folder of the request (“channel_one”). In the third example, the identifier of the broadcast source corresponds to a file name (“channel_two”).

In each of the examples, the initial request includes a parameter that the user can optionally extend during the following step in order to specify a date and a time (parameter UTC, date_time, or time).

Following the initial request acquisition steps 20, 22, and 24, the method moves onto a step 26 of generating requests for transmission on the basis of these previously-acquired initial requests.

The central unit of the receiver terminal 12 includes a program for generating these requests. This program is implemented in conventional manner via a single man-machine interface for the purpose of extending the initial request stored by the receiver terminal 12.

For example, the interface may give the user the option of choosing a set of broadcast channels in which the request is to be made. The system then generates as many requests as there are broadcast channels defined in the set.

Optionally, the interface may give the user the option of inputting a date and a time. By way of example, the date and the time are considered by the system as being the dates and times for broadcasting audiovisual content for which the user seeks to obtain description data.

When such a date and time are not specified, the requests that are generated are associated with the date and time at which they are transmitted.

Also optionally, the user can specify a time interval, either by giving a new date and a new time, or by specifying a duration. Thus, the requests will be considered, for example, as requests for acquiring description data for audiovisual content broadcast in full or in part during said user-defined time interval.

A complete request may thus take the following form:

http://kaas.example.com/channel_one/

metadata.xml?date_time=“1997-07-16T20:20:45.4321Z” &duration=“T02:00:00.0000Z”

Such a request comprises not only the broadcast source (“channel_one”), but also a date (Jul. 16, 1997), a time (8:20 PM and 45.4321 seconds) and an additional parameter referred to as “duration”.

The parameter duration=“T02:00:00.0000Z” indicates that the user seeks to receive the description data for audiovisual content that is to be broadcast in full or in part between the specific date and time and the instant given by said specified data and time plus the duration given in the parameter, following the keyword “duration”.

Also optionally, the user may extend requests by adding a parameter for specifying whether the user desires to receive description data relating to any audiovisual content broadcast before or after the date and time associated with the request.

The complete request can thus take the following form:

http://kaas.example.com/channel_one/

metadata.xml?date_time=“1997-07-16T20:20:45.4321Z”&range=“+0+2”

In addition to the broadcast source (“channel_one”), such a request contains a date (Jul. 16, 1997), a time (8:20 PM and 45.4321 seconds), and an additional parameter referred to as “range”.

The parameter range=“+0+2” indicates that the user desires to receive description data for three items of audiovisual content, the item broadcast at the date and time specified in the request, together with the following two items.

Conventionally, requests can also be extended with keywords that are to be found in the description data desired by the user, or keywords specifying a search domain.

More precisely, the keywords that can be inserted in the request can be the names of elements that appear in the description data for content sent in response by the description servers 16, such as, for example, the elements: “Title” and “Keyword”, which are defined, for example, in the metadata specified by the TV Anytime forum.

Several selection criteria can be added to the initial request in compliance with the syntax rules used for Internet requests (separator “&” for the AND Boolean operator, etc.).

Thereafter the method moves onto step 28 of transmitting requests. As many requests are transmitted as there are broadcast channels specified by the user during the request generation step. Thus, if a plurality of description servers 16 are specified by the user request, each generated request is transmitted to a corresponding description server.

Finally, during a last step 30, the receiver terminal 12 receives the description data for audiovisual content corresponding to the request transmitted during the preceding step. This description data is preferably received in a standard format, for example the format defined by the TV Anytime forum.

Optionally, following this step 30 and depending on a selection made by the user, for example, the method may return to step 26 of generating requests in order to generate new requests associated with a new date and a new time corresponding to the end-of-broadcasting date and time for the audiovisual content for which description data has just been received.

It can clearly be seen that a method of acquiring description data for audiovisual content as implemented by the above-described system enables the description data request to be transmitted automatically in association with at least one date and time to be associated automatically with description data relating to audiovisual content broadcast at a date and a time corresponding to that of the request.

1. A method of acquiring description data for broadcast audiovisual content, the method comprising:
a step (20, 22, 24) of acquiring and storing in a receiver terminal (12) at least one initial information request comprising an address of at least one audiovisual content description server (16);
a step (26) of generating at least one information request on the basis of the initial information request;
a step (28) in which the receiver terminal (12) transmits the information request to the server (16) of audiovisual content descriptions; and
a step (30) of the receiver terminal (12) receiving description data supplied as a function of elements of the request.

2. The method of claim 1, wherein during the reception step (30), audiovisual content description data is supplied as a function of a relationship between at least one date and time associated with the request and the broadcast date and time of the audiovisual content.

3. The method of claim 2, wherein the date and time associated with the request corresponds to the date and time at which the request is transmitted.

4. The method of claim 1, wherein the request as transmitted is identical to the initial request.

5. The method of claim 2, wherein during the request generation step (26), the initial request is extended by specifying at least one date and time.

6. The method of claim 5, wherein, during the reception step (30), the data supplied is that corresponding to audiovisual content broadcast at the date and time specified in the request.

7. The method of claim 5, wherein during the request generation step (26), the initial request is expanded by specifying a number of content items, and in that during the reception step (30), the data supplied corresponds to the requested number of audiovisual content items broadcast starting from the date and time specified in the request.

8. The method of claim 2, wherein during the request generation step (26), the initial request is extended by specifying a time interval, and in that during reception step (30), the data supplied relates to audiovisual content broadcast in the time interval specified in the request.

9. The method of claim 8, wherein the time interval is defined by a start date and time and by an end date and time.

10. The method of claim 8, wherein the time interval is defined by a start date and time and by a duration.

11. The method of claim 2, wherein during the request generation step (26), the initial request is extended by specifying keywords corresponding to the names of description elements for broadcast audiovisual content.

12. The method of claim 2, wherein following the step (30) of receiving description data, the method returns to the request generation step (26) in order to generate at least one new request associated with a new date and a new time corresponding to the end-of-broadcast date and time for the audiovisual content for which description data has just been received.

13. The method of claim 1, wherein the step (20, 22, 24) of acquiring and storing an initial request comprises downloading (20) said request from a description server (16).

14. The method of claim 1, wherein the step (20, 22, 24) of acquiring and storing an initial step comprises the receiver terminal (12) receiving (22) said initial request via a signaling channel associated with an audiovisual content broadcast channel.

15. The method of claim 1, wherein the step (20, 22, 24) of acquiring and storing an initial request comprises a broadcast server (10) supplying (24) an SDP type file corresponding to an address field of a description server (16).

16. The method of claim 1, wherein the description data is supplied in the form of an XML file.

17. The method of claim 1, wherein the request is associated with a single audiovisual content broadcast channel.

18. The method of claim 1, wherein while generating (26) the request for transmission, a set of broadcast channels is defined, and in that during transmission step (28), as many requests are transmitted as there are broadcast channels specified in the request.

19. The method of claim 1, wherein the request generation step comprises adding at least one selection criterion to the initial request.

20. A system for acquiring description data for broadcast audiovisual channel, the system comprising at least one receiver terminal (12) for receiving audiovisual content and at least one audiovisual content description server (16), the receiver terminal (12) including means for acquiring and storing at least one initial information request comprising the address of at least one description server (16), means for generating a request on the basis of the initial request, and means for transmitting said request to the description server, and in that the description server (16) includes means for transmitting to the receiver terminal (12) description data supplied as a function of the request.

21. The system of claim 20, wherein the description server (16) includes means for making an initial request available.

22. The system of claim 20, wherein the system includes at least one audiovisual content broadcast server (10), said server including means for transmitting initial requests together with the broadcast content.

23. An audiovisual content broadcast server (10) for implementing a description acquisition method comprising:
a step (20, 22, 24) of acquiring and storing in a receiver terminal (12) at least one initial information request comprising an address of at least one audiovisual content description server (16);
a step (26) of generating at least one information request on the basis of the initial information request;
a step (28) in which the receiver terminal (12) transmits the information request to the server (16) of audiovisual content descriptions; and
a step (30) of the receiver terminal (12) receiving description data supplied as a function of elements of the request;
the server including transmission means for transmitting initial requests together with the broadcast content.

24. The server of claim 23, wherein the transmission means are regular transmission means.

25. A receiver terminal (12) for receiving audiovisual content to implement a description data acquisition method comprising:
a step (20, 22, 24) of acquiring and storing in a receiver terminal (12) at least one initial information request comprising an address of at least one audiovisual content description server (16);
a step (26) of generating at least one information request on the basis of the initial information request;
a step (28) in which the receiver terminal (12) transmits the information request to the server (16) of audiovisual content descriptions; and
a step (30) of the receiver terminal (12) receiving description data supplied as a function of elements of the request;
the receiver comprising means for storing an initial request and means for generating a request to be transmitted on the basis of the initial request.

26. An audiovisual content description server (16) for implementing a description data acquisition method comprising:
a step (20, 22, 24) of acquiring and storing in a receiver terminal (12) at least one initial information request comprising an address of at least one audiovisual content description server (16);
a step (26) of generating at least one information request on the basis of the initial information request;
a step (28) in which a the receiver terminal (12) transmits the information request to the server (16) of audiovisual content descriptions; and
a step (30) of the receiver terminal (12) receiving description data supplied as a function of elements of the request;
the server comprising means for making an initial request available.
